(19) United States
(12) Patent Application Publication
(10) Pub. No.: US 2011/0014449 A1
(43) Pub. Date: Jan. 20, 2011

(54) CARRIER FILM, IN PARTICULAR FOR AN ADHESIVE TAPE, AND USE THEREOF

(75) Inventors: Bernhard Müssig, Seevetal (DE); Uwe Michel, Berlin (DE)

Correspondence Address: Briscoe, Kurt G.;Norris McLaughlin & Marcus, PA, 875 Third Avenue, 8th Floor, New York, NY, 10022, US

(73) Assignee: TESA SE, Hamburg (DE)

(21) Appl. No.: 12/863,938

(22) PCT Filed: Jan. 12, 2009
(86) PCT No.: PCT/EP09/50266

§ 371 Date: Oct. 4, 2010

(30) Foreign Application Priority Data
Jan. 22, 2008 (DE) 102008005564.6

(51) Int. Cl. C09J 7/02; B32B 27/06; B32B 27/32

(52) U.S. Cl. 428/220; 428/523; 428/352; 428/516; 428/424.8; 428/447

(57) ABSTRACT

The invention relates to a carrier film, in particular for an adhesive tape, which is stretched monoaxially in the longitudinal direction and contains a layer made of polypropylene, characterized in that the tension of the carrier film in the longitudinal direction at 10% elongation is at least 150 N/mm\check{}, preferably at least 200 N/mm\check{}, very particularly preferably at least 250 N/mm\check{}, the layer contains a polypropylene polymer having a content of olefinic co-monomers of less than 2.5 wt.-%, preferably 0 wt.-%, the layer is not nucleated, and a separating lacquer is applied on one side of the layer.

The invention relates to a monoaxially oriented carrier film having a layer of polypropylene homopolymer on which a release layer is applied.

A carrier film is a mechanically stable layer for an adhesive tape in roll form or in the form of a label, and is typically composed of a PVC film, a biaxially oriented polyester or polypropylene film or, rarely, a monoaxially oriented or unoriented polypropylene film.

Films with a high longitudinal strength are typically achieved by orienting extruded film webs of partially crystalline thermoplastics. The orientation in question is predominantly biaxial. In exceptional cases, the longitudinal tensile strength of the films is further increased by orientation only in longitudinal direction. Both commercially customary biaxially and monoaxially oriented films based on polypropylene, however, have low tear propagation resistances in transverse direction, in contrast to unoriented films from the blown-film or cast-film process. In practice, in the case of damaged edges of film or adhesive tape (caused by blunt blades on slitting or later unintended damage to the cut edge), this results in the film, or the adhesive tape produced from it, readily suffering tears or tear removal under tensile load.

Where exacting requirements are imposed with regard to tensile strength and tear propagation resistance, films and adhesive tapes are reinforced with filaments or meshes comprising filaments made of glass or plastic. The production of such filament adhesive tapes is very involved from the equipment standpoint and is therefore expensive and susceptible to faults. Besides the base film, there is an additional requirement for the filaments and laminating adhesives (or an additional coating of pressure-sensitive adhesive), and this makes the products more expensive still. Further disadvantages of such filament adhesive tapes are low crease fracture resistance, high thickness, unclean slit edges, and the absence of weldability and recyclability. The production of an adhesive tape of this kind is described in U.S. Pat. No. 4,454,192 A1, for example.

DE 21 04 817 A1 describes a process for producing an adhesive tape carrier of polyolefin (polyethylene or polypropylene). By orientation in the longitudinal direction the intention is to allow a tensile strength in longitudinal direction of 320 N/mm² to be achieved (according to claim 2; no example present). Draw ratio and attained stress at 10% elongation are not disclosed.

Subject matter of EP 0 255 866 A1 is a polypropylene film oriented biaxially or in longitudinal direction. The addition of elastomeric components increases the tensile impact strength in transverse direction. This measure, however, results in a deterioration in the tensile strength and in the tear propagation resistance in transverse direction. The draw ratio in longitudinal direction is 1:5.5 to 1:7. Tensile strengths of 12 to 355 N/mm² are achieved. Details of the stresses at 10% elongation are not given.

At the end of the 1980s, the company Beiersdorf (Hamburg, Germany) marketed a tear-open strip exhibiting a reduced propensity toward tear removal. This strip contained a longitudinally oriented carrier film from the company NOPI (Harrislee, Germany) which was produced by coextruding raw materials of different toughnesses and had a draw ratio of 1:7.5. The strong outer coextrusion layer, in accordance with the principle of impact modifiers, reduces the formation of microtears when the products are slit with sharp blades. It does not, however, prevent tears caused by subsequently damaged edges (for example, during transport of the roll or during application to the carton). The outer layer contains 60% by weight of polypropylene copolymer with about 5% by weight of ethylene and, to increase the toughness, 40% by weight of SBS rubber, which impairs the light stability and leads in particular to reduced tensile strength (160 N/mm²) and reduced stress at 10% elongation (70 N/mm²) of the film in longitudinal direction. The less tough main layer contains 92% by weight of the polypropylene copolymer and 8% by weight of the SBS rubber. The SBS rubber reduces the tear propagation resistance of a single-layer film of pure polypropylene copolymer with the same draw ratio from around 240 N/mm to 70 N/mm.

DE 44 02 444 A1 relates to an adhesive tape which possesses tensile strength and is based on monoaxially oriented polyethylene. It is possible in some respects to achieve mechanical properties similar to those of corresponding polypropylene products. Polyethylene, however, has a significantly lower heat resistance than polypropylene, which is manifested disadvantageously not only during the production of the adhesive tape (drying of adhesive layers or other layers in the oven) but also in the course of subsequent packaging applications as a grip tape, adhesive carton-sealing tape, tear-open strip or carton reinforcement strip. The adhesive tapes on the cartons often become hot, for example as they pass through printing machines or after the cartons have been filled with hot goods (foodstuffs, for example). Another disadvantage of polyethylene films (including oriented polyethylene films) in comparison to polypropylene films is the significantly lower force at 10% elongation. As a result of the greater elongation for a given force, grip tapes or adhesive carton-sealing tapes produced from such films tend to detach under tensile load, and carton reinforcement strips cannot prevent cartons suffering tears. The draw ratio in longitudinal direction and attainable stresses at 10% elongation are not disclosed. Tensile strengths are achieved of 102 to 377 N/mm².

The draw ratio of commercially customary, monoaxially oriented polypropylene films which are used as a carrier in an adhesive tape is approximately 1:7. A draw ratio of, for example, 1:7 indicates that a section of the primary film which is 1 m in length produces a section of oriented film with a length of 7 m. The draw ratio is often denoted as the ratio of the linear speed prior to orientation to the linear speed after orientation. The numerical figures used in the text below relate to the drawing operation.

An adhesive tape with a carrier comprising monoaxially oriented film can be provided with a release coating if it is to have easy unwind.

If the draw ratio is increased in order to increase the stress at 10% elongation, it is found that, above a draw ratio of 1:8, the film becomes damaged by a conventional release coating based on polyvinyl stearylcarbamate in toluene. The release-coated film surface is sensitive to friction. If friction is generated on the coated surface with an eraser, the surface breaks down into fine fibers. Fiberization of the surface through friction in coating or slitting units may lead to delamination of the film (“shredding”) even as the adhesive tape is being unwound.

In operational practice, cartons are provided with adhesive tapes for reinforcement or for tear-opening, and are then stacked. When individual unerected cartons are withdrawn from the stack, friction occurs against the adhesive tape. Friction also occurs when the cartons are being processed on packaging lines. Operational frictions of these kinds lead to the extraction of polypropylene fibers from the surface.

Toluene as a common solvent for release coatings (release agents) on its own has a damaging effect, which is intensified further by release agents such as polyvinyl stearylcarbamate. The degree of such damage increases as the draw ratio goes up (for example, 1:10). If a silicone-based release coating is used, the consequences are even more serious. The film is damaged even more greatly by silicone than by polyvinyl stearylcarbamate. On the one hand, the damage occurs even at lower draw ratios than 1:8, and, on the other hand, the damage to the film is observed not only on the side of the release coating but even on the opposite side, as if the silicone migrated through the film. If an adhesive tape of this kind is bonded and is then to be removed from the substrate again, the film splits and there are therefore residues of adhesive tape.

Commercially customary, monoaxially oriented polypropylene films for adhesive tapes are produced from polypropylene block copolymer having a flexural modulus of approximately 1200 MPa or from a mixture of a relatively hard polypropylene and a soft PE-LLD having a similar average flexural modulus. If an attempt is made to raise the force at 10% elongation by using polypropylene with a higher flexural modulus than usual, instead of by greater orientation, it is found that this measure as well is accompanied by damage to the film through release coatings. This becomes very marked in the case of films made from polypropylene raw materials that have a flexural modulus of 1600 MPa or more, and becomes particularly extreme from a flexural modulus of 2000 MPa.

It is an object of the invention to provide a carrier film, in particular for an adhesive tape, which has a very high tensile modulus, or a very high stress at 10% elongation in longitudinal direction, which is not damaged by a release coating, particularly not even by a silicone-based released coating, and which does not have the aforementioned disadvantages of the prior-art films.

This object is achieved by means of a film as characterized in more detail in the main claim. The dependent claims describe advantageous embodiments of the invention. Furthermore, the use of the film of the invention is encompassed by the concept of the invention.

The invention accordingly provides a carrier film, in particular for an adhesive tape, which is oriented monoaxially in the longitudinal direction and which comprises a layer of polypropylene, where
the tension of the carrier film in longitudinal direction at 10% elongation is at least 150 N/mm², preferably at least 200 N/mm², very preferably at least 250 N/mm²,
the layer comprises a polypropylene polymer having an olefinic comonomer content of less than 2.5% by weight, preferably 0% by weight,
the layer is not nucleated,
and a release coating is applied on one side of the layer.

In the present invention, the negative effects outlined can be prevented by a layer of polypropylene containing at least 97.5% by weight of propylene.

A layer of polyethylene as well is more resistant to damage by release coats than a layer of polypropylene block copolymer or of a mixture of a polypropylene and a polyethylene. Polyethylene, however, makes virtually no contribution to the intended high tensions at low elongation, in contrast to a polypropylene polymer of the invention. Where a film is composed of a polyethylene layer and of a polypropylene coextrusion layer, the adhesion of the layers to one another is weak. If a little of the main component of the other layer is mixed into each layer, the adhesion can be improved, but polyethylene, in turn, makes hardly any contribution to the desired mechanical properties in longitudinal direction, and, in particular, a layer composed of such a mixture is more sensitive in turn to damage by release coating, particularly in the case of high orientation, in order to produce the desired mechanical properties.

The carrier film can be produced in analogy to the relatively simple extrusion process for monoaxially oriented polypropylene films. It has an increased stress at 10% elongation, and has tensile strengths in longitudinal direction that lie between those of conventional monoaxially oriented polypropylene films and those of fiber-reinforced carriers for filament adhesive tapes, but does not require the involved process for producing filament adhesive tapes. The polypropylene film most frequently used for adhesive tapes is PP-BO (biaxially oriented polypropylene film). These have very low stresses at 10% elongation.

In order to obtain high tensile strengths and high tensions at 1% and 10% elongation, the conditions in the orienting operation ought to be selected such that the draw ratio is the maximum technically implementable draw ratio for the respective film. In accordance with the invention, the draw ratio in longitudinal direction is preferably at least 1:8, more preferably at least 1:9.5.

If an attempt is made to obtain high stresses at 1% and 10% elongation by nucleation of a customary film recipe, the problem of damage by a release coating likewise occurs. Furthermore, the addition of a nucleating masterbatch does lead to improved transparency in the unoriented film, and yet orientation of this film causes it to take on a whitish opacity, meaning that it is not possible to produce transparent carrier films or carrier films colored in dark shades. The problems can be solved by the absence of nucleating agent from the polypropylene polymer layer situated beneath the release coating. This, accordingly, constitutes an advantageous development of the invention. By “absence of nucleating agent” is meant hereinbelow that the polypropylene polymer does not possess a self-nucleating property by virtue of the polymer composition, such as by modification with 4,4′-oxydibenzenesulfonyl azide, for example, and that the manufacturer does not add a nucleating agent when additizing the polypropylene polymer prior to pelletization, and does not add a nucleating agent during the production of the film of the invention, in the form of a masterbatch, for example.

It is thought that the effect of the nucleating agent is that the partially crystalline polymer forms a different fiber structure during orientation than is the case in the presence of a nucleating agent. It appears that the spaces between the fibers draw up the release coating under suction, a phenomenon which then permanently induces a release effect between the fibers, since the solvent does not cause any damage.

A non-nucleated polypropylene layer, evidently, is able to draw up little, or none at all, of the release coating by suction.

A further influencing parameter discovered is the amount of olefinic comonomer in the polypropylene polymer. The comonomer content is less than 2.5% by weight, preferably 0% by weight. The latter means that a true polypropylene homopolymer is present.

For biaxially oriented polypropylene films, the polypropylenes used include those which, though recorded on the data sheet as being homopolymers, nevertheless contain around 1% to 2% by weight of ethylene, for better processing properties, and hence in a scientific sense are really copolymers.

Examples of olefinic comonomers are ethylene, butylene, and octene. It is assumed that copolymers of propylene form not only the very largely crystalline polypropylene phase but also an amorphous elastomer phase of, for example, EPM rubber. Where the comonomer fraction is high, there is an increase in the volume fraction of the amorphous phase. The skilled worker is aware that this phase is easier to dissolve—by solvents such as toluene, for example—than the crystalline regions. In the case of an oriented film of polypropylene copolymer or polypropylene terpolymer, therefore, it is likely that solvent-sensitive, amorphous spaces will be formed between the fibers of crystalline polypropylene, these spaces being able to take up the release coating and transmit it. The skilled worker supposed that a polypropylene homopolymer, on account of the high hardness in cases of strong orientation, would have a particularly brittle behavior and that therefore, in relation to damage to the surface by release coatings, a PP block copolymer or a mixture of a polypropylene and a toughness enhancer would behave less favorably than PE-LLD.

Where further components are present in excessive quantities in the polypropylene polymer layer, this has negative consequences for the resistance to release coatings. This affects, for example, toughness enhancers such as PE-LLD (LLDPE) or SBS rubber, which are frequently used in monoaxially oriented adhesive-tape films of polypropylene block copolymer. The layer therefore preferably contains less than 10% by weight, more preferably less than 5% by weight, and very preferably no polymers having a propylene content of less than 80% by weight, such as PE-LLD, for example.

According to another preferred embodiment of the invention, on account of the required resistance to release coatings, the nonthermoplastic components content—such components being, for example, fibers, fillers, pigments or antiblocking agents—is preferably less than 5% by weight, more preferably less than 1% by weight, and very preferably there are no nonthermoplastic components present. More particularly the carrier film preferably contains no carbon nanotubes.

For the purpose of optimizing the mechanical properties of the carrier film, besides the layer of polypropylene polymer of the invention, there is at least one coextrusion layer applied on the side facing away from the release coating.

The layer preferably comprises a polypropylene, which likewise preferably has a flexural modulus of at least 1600 MPa, more preferably at least 2000 MPa. The polypropylene in the layer is preferably of predominantly isotactic construction. The melt index ought likewise to be situated in the range suitable for flat-film extrusion. The melt index ought to be situated between 0.3 and 15 g/10 min, preferably in the range of 0.8 and 5 g/10 min (measured at 230° C./2.16 kg). In order to maximize the values for stresses at 1% and 10% elongation and for tensile strengths, it is advantageous to use highly isotactic polypropylene.

In the case of a multilayer construction, the thickness of the layer is preferably 3% to 20%, more preferably 5% to 10%, of the total thickness of the film. In this embodiment the layer serves for protection of a coextrusion layer, which is critical for the mechanical properties of the film, from damage by a release coating.

The layer or layers may, besides the polymers, comprise additives such as antioxidants, light stabilizers, antiblocking agents, lubricants, processing assistants, fillers, dyes and/or pigments.

The carrier film, and an adhesive tape produced using the carrier film, has a tension at 10% elongation in longitudinal direction (machine direction) of at least 150 N/mm², of preferably at least 200 N/mm², of more preferably at least 250 N/mm². In one preferred embodiment it is even possible for tensions of at least 300 N/mm² to be attained.

In a preferred embodiment the carrier film, or an adhesive tape produced using the carrier film, possesses in longitudinal direction (machine direction) a tension at 1% elongation of at least 20 N/mm², preferably at least 40 N/mm² and/or a tensile strength of at least 300 N/mm², preferably at least 350 N/mm². The tear propagation resistance in transverse direction is intended to attain preferably at least 80 N/mm, more particularly at least 220 N/mm.

For the calculation of strength values, the width-related force values are divided by the thickness. In the case where strength values are determined on the adhesive tape, the thickness taken as a basis is not the total thickness of the adhesive tape, but only that of the carrier film.

The thickness of the carrier film is preferably between 25 and 200 μm, more preferably between 40 and 140 μm, very preferably between 50 and 90 μm.

The carrier film preferably does not have rib structures on the surfaces, since such structures impair the adhesion during the orienting operation and do not allow homogeneous orientation. If the film is of multilayer construction, through coextrusion, then it also has no rib structures in its interior, according to one preferred embodiment of the invention, but instead has layers with a plane-parallel orientation, to remove any need to provide a complicated and fault-susceptible die.

The film may be modified by lamination, embossing or radiation treatment. The films may have been given surface treatments. These treatments are, for example, to promote adhesion, corona treatment, flame treatment, fluorotreatment or plasma treatment, or, on the side facing away from the release coating, coatings of solutions or dispersions or liquid, radiation-curable materials.

The carrier film has a release coating on the layer (also called adhesive or nonstick coating), which is composed, for example, of silicone, of acrylates (for example, Primal® 205), of stearyl compounds such as polyvinyl stearylcarbamate or chromium stearate complexes (for example, Quilon® C) or of reaction products of maleic anhydride copolymers and stearylamine. Preference is given to a silicone-based release coating. The silicone may be applied solventlessly or containing solvent, and may be crosslinked by radiation, by a condensation or addition reaction, or physically (for example, by a block structure).

The purpose of release coatings is to make an adhesive tape easier to unwind, in order to prevent high levels of force application and/or stretching of the carrier. The latter may lead to detachment of the adhesive tape, with the stretched carrier retracting after the tape has been adhered.

With particular advantage, the carrier film of the invention can be used in an adhesive tape, by application of an adhesive to one side of the carrier film.

A preferred adhesive tape in accordance with the invention is a film having a self-adhesive or heat-activatable layer of adhesive. The adhesives in question, however, are preferably not sealable adhesives, but rather pressure-sensitive adhesives. For the adhesive tape application, the carrier film is coated on one side with pressure-sensitive adhesive in the form of a solution or dispersion or in 100% form (from the melt, for example), or by coextrusion with the carrier film. The layer of adhesive is located on the side of the film that does not have the release coating. The adhesive layer can be crosslinked by means of heat or high-energy radiation and can if necessary be lined with release film or release paper. Especially suitable pressure-sensitive adhesives are PSAs based on acrylate, natural rubber, thermoplastic styrene block copolymer or silicone.

The general expression “adhesive tape” in the context of this invention encompasses all sheetlike structures, such as two-dimensionally extended films or film sections, tapes with extended length and limited width, tape sections and the like, and also, lastly, die cuts or labels.

In order to optimize the properties it is possible for the self-adhesive employed to have been blended with one or more additives such as tackifiers (resins), plasticizers, fillers, pigments, UV absorbers, light stabilizers, ageing inhibitors, crosslinking agents, crosslinking promoters or elastomers.

Suitable elastomers for blending are, for example, EPDM rubber or EPM rubber, polyisobutylene, butyl rubber, ethylene-vinyl acetate, hydrogenated block copolymers of dienes (for example, through hydrogenation of SBR, cSBR, BAN, NBR, SBS, SIS or IR; such polymers are known, for example, as SEPS and SEBS) or acrylate copolymers such as ACM.

Tackifiers are, for example, hydrocarbon resins (for example, those of unsaturated C₅ or C₇ monomers), terpene-phenolic resins, terpene resins formed from raw materials such as α- or β-pinene, aromatic resins such as coumarone-indene resins or resins of styrene or α-methylstyrene, such as rosin and its derivatives, such as disproportionated, dimerized or esterified resins, in which context it is possible to use glycols, glycerol or pentaerythritol. Particularly suitable are ageing-stable resins without an olefinic double bond, such as hydrogenated resins, for example.

Examples of suitable fillers and pigments are carbon black, titanium dioxide, calcium carbonate, zinc carbonate, zinc oxide, silicates or silica.

Suitable UV absorbers, light stabilizers, and aging inhibitors for the adhesives are those as listed in this specification for the stabilization of the film.

Examples of suitable plasticizers include aliphatic, cycloaliphatic, and aromatic mineral oils, diesters or polyesters of phthalic acid, trimellitic acid or adipic acid, liquid rubbers (for example, nitrile rubbers or polyisoprene rubbers), liquid polymers of butene and/or isobutene, acrylic esters, polyvinyl ethers, liquid resins and plasticizer resins based on the raw materials for tackifier resins, wool wax and other waxes, or liquid silicones.

Examples of crosslinking agents are phenolic resins or halogenated phenolic resins, melamine resins and formaldehyde resins. Examples of suitable crosslinking promoters are maleimides, allyl esters such as triallyl cyanurate, and polyfunctional esters of acrylic and methacrylic acid.

In preferred embodiments the pressure-sensitive adhesive comprises pale and transparent raw materials. Particularly preferred are acrylate PSAs (for example in dispersion form) or PSAs comprising styrene block copolymer and resin (for example, of the kind typical for hotmelt PSAs).

The coating thickness with adhesive is preferably in the range from 18 to 50 g/m², more particularly 22 to 29 g/m². The width of the adhesive-tape rolls is preferably in the range from 2 to 60 mm.

An adhesive tape of this kind is suitable for reinforcing cardboard packaging, particularly in the region of die cuts, as a tear-open strip for cartons, as a carry handle, for pallet securement, and for bundling articles. Examples of such articles include pipes, profiles or stacked cartons (strapping application).

In comparison to the film from EP 0 353 907 A1, the carrier film is produced in only two steps (extrusion, orienting) in-line on one line, and also has very much higher tear propagation resistances in transverse direction (approximately 300 N/cm at 70 μm thickness).

### Test Methods

### Thickness: DIN 53370

Tensile strength: DIN 53455-7-5 in longitudinal direction
Stress at 1% or 10% elongation: DIN 53455-7-5 in longitudinal direction
Elongation at break: DIN 53455-7-5 in longitudinal direction
Melt index: DIN 53735
The Melt Flow Ratio (MFR) melt index is measured in accordance with DIN 53735. For polyethylenes, melt indices are usually specified in g/10 min at 190° C. and a weight of 2.16 kg, and for polypropylenes similarly but at a temperature of 230° C.
   Flexural modulus: ASTM D 790 A

### Density: ASTM D 792

Crystallite melting point: determined by DSC in accordance with ISO 3146
Nomenclature of the plastics: ISO 1043-1
Friction test:
10 strokes with an Edding A 20 eraser having a rounded corner (radius of curvature=5 mm) in machine direction, with an applied pressure of 5 kiloponds on the release-coated side.
   Evaluation: pass=no abrasion;
      fail=fibers are rubbed out of the surface
         Technical adhesive data: AFERA 4001, corresponding to DIN EN 1939

The invention is illustrated below by reference to examples, which do not restrict it.

### EXAMPLES

### Raw Materials

### Dow 7CO₆:

PP-C, MFI 1.5 g/10 min, non-nucleated, flexural modulus 1280 MPa, crystallite melting point 164° C. (Dow Chemical)

### Dow Inspire 404.01:

Polypropylene, MFI 3 g/10 min, nucleated, flexural modulus 2068 MPa, nucleated with a polymeric nucleating agent in accordance with US 2003/195300 A1, crystallite melting point 164° C. (Dow Chemical)

### PP 3281:

PP-H, MFI 1.1 g/10 min, non-nucleated, density 0.905 g/cm³, flexural modulus 1380 MPa, crystallite melting point 165° C. (Atofina)

### Moplen HP 556 E:

PP-H, non-nucleated, MFI 0.8 g/10 min, density 0.905 g/cm, flexural modulus 1700 MPa, crystallite melting point 162° C. (Basell)

### Moplen HP 501 D:

Copolymer with 1.5% by weight ethylene, MFI 0.7 g/10 min, non-nucleated, flexural modulus 1450 MPa, crystallite melting point 161° C. (Basell)

### HB 205 TF:

PP-H, MFI 0.9 g/10 min, density 0.905 g/cm₃, flexural modulus 1200 MPa, crystallite melting point 163° C. (Borealis)

### Dowlex 2032:

PE-LLD (random copolymer of ethylene with 1-octene), MFI 2.0 g/10 min, density 0.9260 g/cm³, crystallite melting point 124° C. (Dow Chemical)

### Remafingelb HG AE 30:

PP pigment masterbatch with translucent pigment (Clariant Masterbatches)

### ADK STAB NA-11 UH:

Nucleating agent (Adeka Palamarole)

### Release Coat RA95D:

PVSC=polyvinyl stearylcarbamate (k+k-Chemie)

### Dehesive 940A:

Silicone solution (Wacker Chemical)

### Crosslinker V24:

Crosslinking agent (Wacker Chemical)

### Catalyst OL:

Catalyst agent (Wacker Chemical)

### Example 1

A two-layer film is coextruded on a single-screw extrusion unit with a flat die with flexible die lip, followed by a chill roll station and a single-stage short-gap orienting unit. The coextrusion layer is composed of Inspire D 404.01, and the layer of PP 3281. The die temperature is 235° C. The draw ratio is 1:10.

The film is corona-pretreated on both sides, coated on the layer of the invention with a 0.5% release solution of Release Coat RA95D in toluene, and dried. The adhesive is mixed in the melt from 42% by weight of SIS elastomer, 20% by weight of pentaerythritol ester of hydrogenated rosin, 37% by weight of a C₅ hydrocarbon resin having an R&B value of 85° C., and 1% by weight of Irganox® 1010 antioxidant, and is applied at 150° C. with a nozzle to the bottom face of the film. The adhesive tape is subsequently wound to form a stock roll, and for further testing is slit to a width of 15 mm.

Technical adhesive data:
bond strength to steel 2.2 N/cm
unwind force at 0.3 m/min 1.1 N/cm
coat weight 23 g/m².
   Test results:
   Film properties:

| | | |
|---|---|---|
| Carrier thickness after orientation | 75 | μm |
| Thickness of coextrusion layer | 70 | μm |
| Thickness of the layer | 5 | μm |
| Stress at 1% elongation | 65 | N/mm² |
| Stress at 10% elongation | 280 | N/mm² |
| Tensile strength | 310 | N/mm² |

| | |
|---|---|
| Elongation at break | 8% |
| Friction test | pass |

### Example 2

The film is produced in the same way as in example 1, but with the draw ratio set at 1:8. Raw material used for the coextrusion layer is a mixture of 98.9% by weight Moplen HP 556 E and 1.1% by weight Remafingelb HG AE 30. The layer is composed of PP 3281.

The film is corona-pretreated on both sides and then provided on the top face with a silicone release coating. The latter is composed of 21 800 parts by weight of heptane, 3126 parts by weight of Dehesive 940A, 8 parts by weight of methylbutynol, 23 parts by weight of Crosslinker V24, and 31 parts by weight of Catalyst OL. The bottom face is provided with a primer comprising natural rubber, cyclorubber, and 4,4′-diiso-cyanatodiphenylmethane. The adhesive is dissolved in hexane, in a kneading apparatus, from 40% by weight of natural rubber SMRL (Mooney 70), 10% by weight of titanium dioxide, 37% by weight of a C₅ hydrocarbon resin having an R&B value of 95° C., and 1% by weight of Vulkanox® BKF antioxidant. The 20% strength by weight of adhesive is applied using a coating bar to the primed bottom face of the film, and is dried at 115° C. The adhesive tape is then wound to form a stock roll and for further testing is slit to a width of 15 mm.

Technical adhesive data:
bond strength to steel 1.9 N/cm
unwind force at 0.3 m/min 0.2 N/cm
coat weight 24 g/m².
   Test results:
   Film properties:

| | | |
|---|---|---|
| Carrier thickness after orientation | 64 | μm |
| Thickness of coextrusion layer | 60 | μm |
| Thickness of the layer | 4 | μm |
| Stress at 1% elongation | 52 | N/mm² |
| Stress at 10% elongation | 306 | N/mm² |
| Tensile strength | 330 | N/mm² |

| | |
|---|---|
| Elongation at break | 20% |
| Friction test | pass |

### Example 3

The film is produced as in example 1; the layer and the coextrusion layer are composed of Moplen HP 501 D; the draw ratio is 1:9.8.

Test results:
Film properties:

| | | |
|---|---|---|
| Carrier thickness after orientation | 35 | μm |
| Thickness of coextrusion layer | about 32 | μm |
| Thickness of the layer | about 3 | μm |
| Stress at 1% elongation | 60 | N/mm² |
| Stress at 10% elongation | 357 | N/mm² |
| Tensile strength | 502 | N/mm² |

| | |
|---|---|
| Elongation at break | 17% |

A) The film is corona-pretreated on both sides and then processed further as in example 2.
Result of rubbing test: fail (silicone).
   B) The film is corona-pretreated on both sides and then processed further as in example 1.
Result of rubbing test: pass (polyvinyl stearylcarbamate).

This film as well is inventive. It passes the rubbing test with a release based on polyvinyl stearylcarbamate, although the rubbing test with a release based on silicone exhibits failure (for the reasons outlined above).

### Example 4

The film is produced as in example 1; the coextrusion layer is composed of Moplen HP 556 E; the draw ratio is 1:9.7. Corona treatment and coating take place as in example 2.

Test results:
Film properties:

| | | |
|---|---|---|
| Carrier thickness after orientation | 64 | μm |
| Thickness of coextrusion layer | 60 | μm |
| Thickness of the layer | 4 | μm |
| Stress at 1% elongation | 68 | N/mm² |
| Stress at 10% elongation | 290 | N/mm² |
| Tensile strength | 300 | N/mm² |

| | |
|---|---|
| Rubbing test | pass |

### Example 5

The film is produced in the same way as in example 1, but with the draw ratio set at 1:8 and the temperature of the drawing rolls being reduced. Raw material used for the coextrusion layer is a mixture of 98.9 parts by weight of Moplen HP 501 D, 0.9 part by weight of Remafingelb HG AE 30, and 0.2 part by weight of ADK STAB NA-11 UH. The inventive layer is composed of Moplen HP 556 E.

Test results:
Film properties:

| | | |
|---|---|---|
| Carrier thickness after orientation | 64 | μm |
| Thickness of the coextrusion layer | 60 | μm |
| Thickness of the layer | 4 | μm |
| Stress at 1% elongation | 36 | N/mm² |
| Stress at 10% elongation | 256 | N/mm² |
| Tensile strength | 290 | N/mm² |

| | |
|---|---|
| Elongation at break | 30% |
| Rubbing test | pass |

### Comparative Example 1

Film and coating are produced as in example 1, but the film is without a layer. The release is therefore applied to the layer of Inspire D 404.01.

Test results:
Film properties:

| | | |
|---|---|---|
| Carrier thickness after orientation | 70 | μm |
| Stress at 1% elongation | 68 | N/mm² |
| Stress at 10% elongation | 290 | N/mm² |
| Tensile strength | 317 | N/mm² |

| | |
|---|---|
| Elongation at break | 7% |
| Rubbing test | fail |

### Comparative Example 2

The film is produced as in example 5, but the layer has the same composition as the coextrusion layer, namely a mixture of 98.9 parts by weight of Moplen HP 501 D, 0.9 part by weight of Remafingelb HG AE 30, and 0.2 part by weight of ADK STAB NA-11 UH.

Test results:
Film properties:

| | | |
|---|---|---|
| Carrier thickness after orientation | 65 | μm |
| Thickness of the coextrusion layer | 60 | μm |
| Thickness of the layer | 5 | μm |
| Stress at 1% elongation | 37 | N/mm² |
| Stress at 10% elongation | 258 | N/mm² |
| Tensile strength | 310 | N/mm² |

| | |
|---|---|
| Elongation at break | 32% |

A) The film is corona-pretreated on both sides and then processed further as in example 2.
Result of rubbing test: fail (silicone).
   B) The film is corona-pretreated on both sides and then processed further as in example 1.
Result of rubbing test: fail (polyvinyl stearylcarbamate).

### Comparative Example 3

A film is produced in the same way as in comparative example 1, from 99.8% by weight of Dow 7C06 and 0.2% by weight of ADK STAB NA-11 UH, with a draw ratio of 1:6.3.

Test results:

| | | |
|---|---|---|
| Carrier thickness after orientation | 80 | μm |
| Stress at 1% elongation | 26 | N/mm² |
| Stress at 10% elongation | 162 | N/mm² |
| Tensile strength | 245 | N/mm² |

| | |
|---|---|
| Elongation at break | 21% |
| Rubbing test | fail |

### Comparative Example 4

A film is produced in the same way as in comparative example 3, from Dow 7C06 with a draw ratio of 1:6.1 and with a somewhat higher temperature of the drawing rolls. Corona treatment and coating take place as in example 1.

Test results:

| | | |
|---|---|---|
| Carrier thickness after orientation | 80 | μm |
| Stress at 1% elongation | 19 | N/mm² |
| Stress at 10% elongation | 142 | N/mm² |
| Tensile strength | 247 | N/mm² |

| | |
|---|---|
| Elongation at break | 27% |
| Rubbing test | pass |

The positive result in the rubbing test is achieved at the expense of weaker mechanical data.

### Comparative Example 5

The film is produced as in example 1, but the layer is composed of Dow 7C06. Corona treatment and coating take place as in example 2.

Test results:
Film properties:

| | | |
|---|---|---|
| Carrier thickness after orientation | 75 | μm |
| Thickness of the coextrusion layer | 70 | μm |
| Thickness of the layer | 5 | μm |
| Stress at 1% elongation | 60 | N/mm² |
| Stress at 10% elongation | 270 | N/mm² |
| Tensile strength | 300 | N/mm² |

| | |
|---|---|
| Elongation at break | 11% |
| Rubbing test | fail |

### Comparative Example 6

The film is produced as in comparative example 4; the draw ratio is 1:7.5 and the film is composed of conventional polypropylene homopolymer HB 205 TF. Corona treatment and coating take place as in example 1.

Test results:
Film properties:

| | | |
|---|---|---|
| Carrier thickness after orientation | 55 | μm |
| Stress at 1% elongation | 25 | N/mm² |
| Stress at 10% elongation | 130 | N/mm² |
| Tensile strength | 370 | N/mm² |

| | |
|---|---|
| Elongation at break | 40% |
| Rubbing test | pass |

The positive result in the rubbing test is achieved at the expense of weaker mechanical data (tension at 1% and 10% elongation).

### Comparative Example 7

The film is produced as in comparative example 4; the draw ratio is 1:7.5, and the film is composed of 85% by weight of HB 205 TF and 15% by weight of Dowlex 2032.

Test results:
Film properties:

| | | |
|---|---|---|
| Carrier thickness after orientation | 40 | μm |
| Stress at 1% elongation | 18 | N/mm² |
| Stress at 10% elongation | 88 | N/mm² |
| Tensile strength | 245 | N/mm² |

| | |
|---|---|
| Elongation at break | 60% |

A) The film is corona-pretreated on both sides and then processed further in accordance with example 2.
Result of rubbing test: fail (silicone).
   B) The film is corona-pretreated on both sides and then processed further in accordance with example 1.
Result of rubbing test: pass (polyvinyl stearylcarbamate).

1. A carrier film for an adhesive tape, which is oriented monoaxially in longitudinal direction and which comprises a layer of polypropylene, wherein in that the tension of the carrier film in longitudinal direction at 10% elongation is at least 150 N/mm², the layer comprises a polypropylene polymer having an olefinic comonomer content of less than 2.5% by weight, the layer is not nucleated, and a release coating is applied on one of the sides of the layer.

2. The carrier film according to claim 1, wherein the layer contains less than 10% by weight of polymers having a propylene content of less than 80% by weight, or in that more preferably 0% by weight of polymers having a propylene content of less than 80% by weight are present.

3. The carrier film according to claim 1, wherein the layer has a nonthermoplastic components content of less than 5% by weight.

4. The carrier film according to claim 1, wherein the carrier film is free of carbon nanotubes.

5. The carrier film according to, wherein the carrier film
has a draw ratio in longitudinal direction of at least 1:8,
has a tensile strength in longitudinal direction of at least 300 N/mm², and
has a tension in longitudinal direction at 1% elongation of at least 20 N/mm².

6. The carrier film according to claim 1, wherein the polypropylene polymer of the layer has a melt index of 0.3 to 15 g/10 min and a flexural modulus of at least 1600 MPa.

7. The carrier film according to claim 1, wherein the carrier film has a thickness of 25 to 200 μm.

8. The carrier film according to claim 1, wherein the layer, on the side opposite to the release coating has a coextrusion layer which comprises a polypropylene having a flexural modulus of at least 1600 MPa and is nucleated.

9. The carrier film according to claim 8, wherein the thickness of the layer is 3% to 20% of the total film thickness.

10. The carrier film according to claim 1,
wherein the release coating comprises polyvinyl stearylcarbamate or silicone.

11. The carrier film according to claim 1 wherein the film comprises an adhesive applied to at least one side of the film.

12. (canceled)

13. The carrier film according to claim 1 wherein the tension of the carrier film in longitudinal direction at 10% elongation is at least 200 N/mm².

14. The carrier film according to claim 10 wherein the release coating comprises silicone.
